(19) United States
(12) Patent Application Publication
(10) Pub. No.: US 2009/0079547 A1
(43) Pub. Date: Mar. 26, 2009

(54) Method, Apparatus and Computer Program Product for Providing a Determination of Implicit Recommendations

(75) Inventors: Markku Oksanen, Helsinki (FI); Franklin Reynolds, Bedford, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/860,722

(22) Filed: Sep. 25, 2007

(51) Int. Cl. H04Q 5/22

(52) U.S. Cl. 340/10.3

(57) ABSTRACT

An apparatus for providing a determination of implicit recommendations may include a processing element. The processing element may be configured to receive sensor data from at least one sensor, determine context information associated with the at least one sensor, and determine an implicit recommendation based on the sensor data and the context information.

### TECHNOLOGICAL FIELD

Embodiments of the present invention relate generally to affective computing technology and, more particularly, relate to a method, device, mobile terminal and computer program product for providing implicit recommendations.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the types of applications for which such mobile electronic devices may be employed is also experienced. As such, mobile electronic devices are being incorporated into the daily lives of many people to the point that mobile electronic devices may be considered vital by many individuals. Accordingly, mobile electronic devices are becoming ubiquitous in modern society.

Meanwhile, the information age also presents challenges with regard to getting information to and/or from a particular target audience due to the ease with which information and content can be accessed or consumed. Thus, for example, marketers, sellers of goods and services, event coordinators and many others may desire feedback, either implicitly or explicitly, from customers or potential customers regarding their products, advertisements, services, etc. In fact, it is not uncommon for exit polls, surveys, or other opinion polls to be commissioned in order to determine such information. However, such polling and/or surveys may be considered by some individuals to be an annoyance, which they may attempt to avoid.

Accordingly, it may be desirable to provide a way to receive feedback or recommendations from individuals without necessarily requiring an interaction with the individuals themselves.

### BRIEF SUMMARY

A method, apparatus and computer program product are therefore provided to enable the provision of implicit recommendations. Given the ubiquitous nature of mobile electronic devices and the propensity of many individuals to ensure that they have nearly continuous possession of their corresponding mobile electronic devices, such devices may be uniquely able to provide certain types of useful information regarding locations, events or content. In this regard, a mobile terminal could be employed to extract information from a user that may be indicative of the user's “affective state”. In other words, the affect that a particular content, location or event has upon the user may be determined by sensing data relative to the user based on the user's context. The affective state, or emotional state of the user responsive to the content, location or event, may be indicative of an implicit recommendation of the user regarding the content, location or event. In other words, by monitoring certain sensor data in connection with the context associated with the collection of the sensor data, it may be possible to determine whether the user is happy, sad, interested, bored, excited, angry, tense, or a host of other emotions or affective states. The affective state may then be used with or without context for determining an implicit recommendation. This information may be gathered in an unobtrusive manner to ensure that the user is not bothered by the gathering of the information and, therefore, is more likely to permit such gathering. Thus, for example, a mobile terminal may serve as a conduit through which information may be extracted from an individual indicative of the implicit recommendation of the individual with respect to a particular content item, location or event. Accordingly, polling, ranking, surveying, and even searching operations may be improved as a result. However, it should be noted that while an implicit recommendation may not be perfectly accurate with regard to representing each user's actual feelings with regard to a location, content or event, a plurality of implicit recommendations is statistically likely to provide useful and valuable information.

In one exemplary embodiment, a method of providing the determination of implicit recommendations is provided. The method may include receiving sensor data from at least one sensor, determining context information associated with the at least one sensor, and determining an implicit recommendation based on the sensor data and the context information.

In another exemplary embodiment, a computer program product for providing the determination of implicit recommendations is provided. The computer program product includes at least one computer-readable storage medium having computer-readable program code portions stored therein. The computer-readable program code portions include first, second and third executable portions. The first executable portion is for receiving sensor data from at least one sensor. The second executable portion is for determining context information associated with the at least one sensor. The third executable portion is for determining an implicit recommendation based on the sensor data and the context information.

In another exemplary embodiment, an apparatus for providing the determination of implicit recommendations is provided. The apparatus may include a processing element. The processing element may be configured to receive sensor data from at least one sensor, determine context information associated with the at least one sensor, and determine an implicit recommendation based on the sensor data and the context information.

In another exemplary embodiment, an apparatus for providing the determination of implicit recommendations is provided. The apparatus includes means for receiving sensor data from at least one sensor, means for determining context information associated with the at least one sensor, and means for determining an implicit recommendation based on the sensor data and the context information.

In yet another exemplary embodiment, an apparatus (e.g., a server) for providing processing with regard to implicit recommendations is provided. The apparatus may include a a processing element configured to receive an implicit recommendation, receive a search query related to an event, location or content, and provide search results based at least in part on the implicit recommendation. The implicit recommendation may be determined based on sensor data and associated context information.

Embodiments of the invention may provide a method, apparatus and computer program product for advantageous employment in a mobile electronic device environment, such as on a mobile terminal capable of enabling communication with other terminals or devices, creating and/or viewing content items and objects related to various types of media, and/or executing applications of varying types. As a result, for example, better feedback may be extracted from mobile terminal users in a way that is not distracting or bothersome to the users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing for the determination of implicit recommendations according to an exemplary embodiment of the present invention; and

FIG. 4 is a flowchart according to an exemplary method for providing the determination of implicit recommendations according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

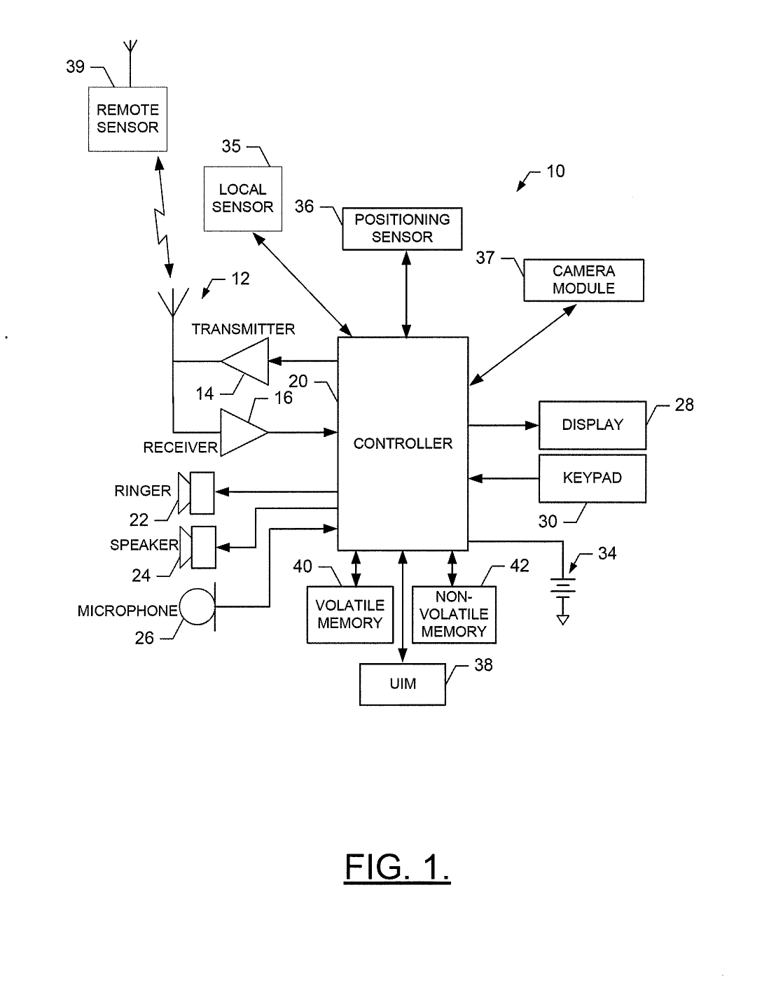

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the apparatus, such as the controller 20, includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 may include or otherwise be in communication with one or more sensors. For example, a local sensor 35 (or multiple local sensors) may be disposed at, or otherwise be a portion of, the mobile terminal 10. The local sensor 35 may be any device or means capable of determining raw data relating to an individual or the individual's environment. For example, the local sensor 35 could be a device for determining temperature, skin conductivity, motion, acceleration, light, time, biometric data, voice stress and/or other characteristics related to an individual. Thus, for example, the local sensor 35 could be a thermometer, accelerometer, camera, light sensor, clock, biometric sensor (e.g., a pulse rate sensor, body temperature sensor, or the like), etc. The local sensor 35 could be an integral part of the mobile terminal 10 (e.g., a part of the casing of the mobile terminal 10) or proximate to, attached to or otherwise in communication with the mobile terminal 10. In an exemplary embodiment, the local sensor 35 may operate automatically or without user intervention. However, in an alternative embodiment, the local sensor 35 may be configured to operate to gather information, or to communicate gathered information, only in response to user intervention.

In addition, the mobile terminal 10 may include (or the local sensor 35 could be embodied as) a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Alternatively or additionally, the positioning sensor 36 may be configured to utilize BT, UWB, Wi-Fi or other radio signals to determine the location of a mobile terminal 10 in an indoor environment using known protocols and/or algorithms. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 may include a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG standard format.

In an exemplary embodiment, the camera module 37 could be used to determine motion based on changes to an image detected by a lens of the camera module 37. The camera module could also be used to determine other characteristics related to an individual such as, for example, time of day, weather conditions (e.g., overcast or sunny), location (e.g., indoors or outdoors, etc.) based on lighting conditions. Location could also be determined by recognition of landmarks detected from images captured by the camera module 37. Additionally, location information from the positioning sensor 36 may be used in conjunction with the camera module 37 for determinations regarding location, time of day and/or weather conditions. As such, the camera module 37 could also be an example of a sensor. In an exemplary embodiment, the microphone 26 may be used to capture voice data, which may be analyzed to determine a stress level of the speaker, for example, by comparing the speaker's rate of speech, tone, volume, pitch and/or other characteristics of the speaker's speech. As such, the microphone 26 may be an example of a local sensor as well.

In an exemplary embodiment, rather than disposing sensors at the mobile terminal 10, one or more remote sensors may be employed. In this regard, a remote sensor 39 may be in communication with the mobile terminal 10 to provide the mobile terminal 10 with data gathered at a sensor disposed remotely with respect to the mobile terminal 10. For example, a sensor could be disposed in or as a part of a clothing article, a jewelry article, a watch, or any other article that may be in contact with or otherwise capable of gathering data associated with an individual associated with the mobile terminal 10. The remote sensor 39 could be any of the sensors described above, except of course, that the remote sensor 39 may not be a part of or in physical contact with the mobile terminal 10. In an exemplary embodiment, communication between the remote sensor 39 and the mobile terminal 10 may be accomplished via a wireless communication mechanism such as a short range radio communication mechanism (e.g., Bluetooth or Wibree).

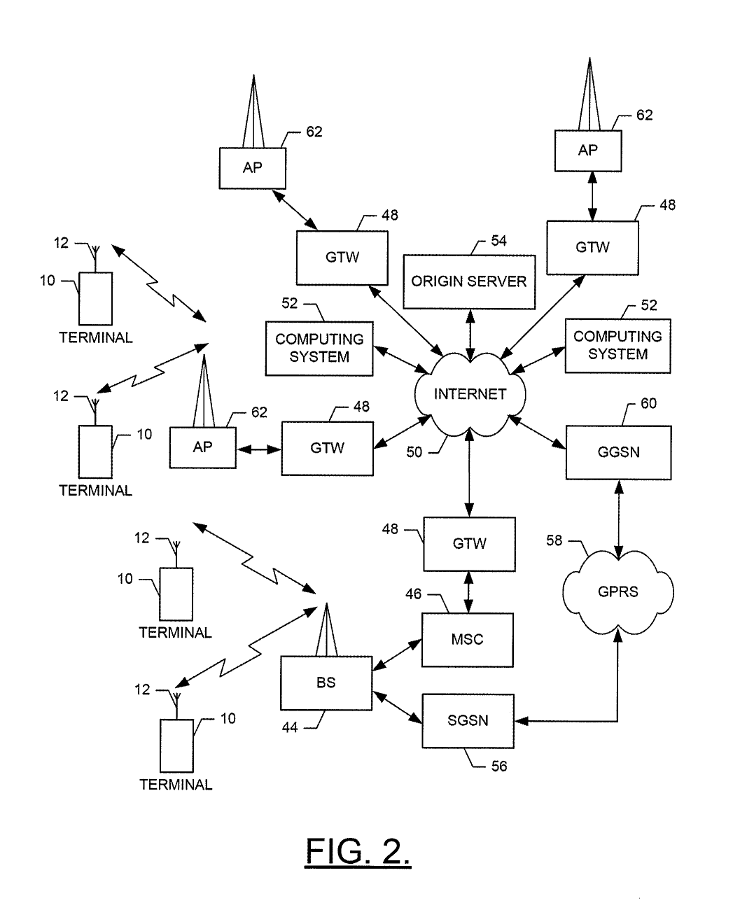

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication between the mobile terminal 10 and a server or other network device. As such, it should be understood that the system of FIG. 2 need not be employed for communication between the mobile terminal and a network device, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

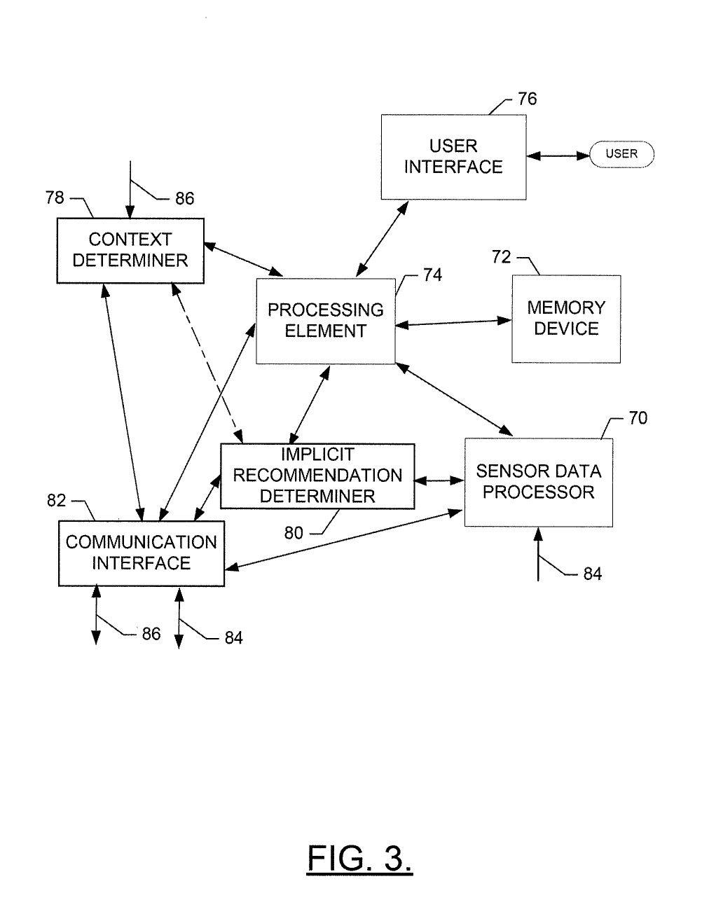

An exemplary embodiment of the invention will now be described with reference to FIG. 3, in which certain elements of a system for providing the determination of implicit recommendations are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, a handheld computer, a server, a proxy, etc. Alternatively, embodiments may be employed on a combination of devices including, for example, those listed above. Thus, for example, embodiments of the present invention may be practiced in a server/client environment in which the mobile terminal 10 may be a client device and the server may perform functions described below and provide a corresponding output to the client device based at least in part on sensor data communicated to the server by the client device. It should also be noted that while FIG. 3 illustrates one example of a configuration of a system for providing implicit recommendations, numerous other configurations may also be used to implement embodiments of the present invention.

An implicit recommendation may be defined as an implied opinion of a user determined on the basis of a user reaction to a particular stimulus or set of stimuli. As such, as discussed above, the implicit recommendation may not be, and need not necessarily be an accurate reflection of the actual user opinion in all cases. Rather, statistical analysis of what sensor data may be expected to correlate with a given affective state of a user in a given context may be used to assign, based on a statistical likelihood, an affective state and ultimately an implicit recommendation to be associated with given sensor data and context combinations. Other statistical analysis tools such as, for example, large sample sizes and using actual feedback to train algorithms for improved implicit recommendation determination based on the actual feedback may be useful in improving results related to assigning an implicit recommendation related to a particular location, event or content item.

Referring now to FIG. 3, a system for providing determination of implicit recommendations is provided. The system may be embodied in hardware, software or a combination of hardware and software for use by a device or combination of devices such as the mobile terminal 10 and/or a server. The system may include a sensor data processor 70, a memory device 72, processing element 74, a user interface 76, a context determiner 78, the implicit recommendation determiner 80 and/or a communication interface 82. In exemplary embodiments, the sensor data processor 70, the memory device 72, the processing element 74, the user interface 76, the context determiner 78, the implicit recommendation determiner 80 and/or the communication interface 82 may be in communication with each other via any wired or wireless communication mechanism. In an exemplary embodiment, each of the sensor data processor 70, the memory device 72, the processing element 74, the user interface 76, the context determiner 78, the implicit recommendation determiner 80 and/or the communication interface 82 may be controlled by or otherwise embodied as an apparatus, such as the processing element 74 (e.g., the controller 20 or a processor of a server or other device). Processing elements such as those described herein may be embodied in many ways. For example, the processing element 74 may be embodied as a processor, a coprocessor, a controller or various other processing means or devices including integrated circuits such as, for example, an ASIC (application specific integrated circuit); and all of which are generally referred to as an apparatus.

In an exemplary embodiment, all of the sensor data processor 70, the memory device 72, the processing element 74, the user interface 76, the context determiner 78, the implicit recommendation determiner 80 and the communication interface 82 may be disposed at a single device such as, for example, the mobile terminal 10. However, as indicated above, if a client/server embodiment is employed, for example, one or more of the sensor data processor 70, the memory device 72, the processing element 74, the context determiner 78, the implicit recommendation determiner 80 and/or the communication interface 82 may be disposed at the server while the user interface 76 and remaining ones of the sensor data processor 70, the memory device 72, the processing element 74, the context determiner 78, the implicit recommendation determiner 80 and/or the communication interface 82 may be disposed at the client (e.g., the mobile terminal 10). As another alternative, portions of the sensor data processor 70, the memory device 72, the processing element 74, the user interface 76, the context determiner 78, the implicit recommendation determiner 80 and/or the communication interface 82 may be split between server and client or duplicated at the server and/or client. Other configurations are also possible.

The memory device 72 (e.g., the volatile memory 40 or the non-volatile memory 42) may be an optional element configured to store a plurality of content items, instructions, data and/or other information. The memory device 72 may store, among other things, content items related to position history, current or historical sensor data, application data or instructions, etc. In an exemplary embodiment, the memory device 72 may store instructions for an application for determining implicit recommendations according to an embodiment of the present invention for execution by the processing element 74.

The user interface 76 may include, for example, the keypad 30 and/or the display 28 and associated hardware and software. It should be noted that the user interface 76 may alternatively be embodied entirely in software, such as may be the case when a touch screen is employed for interface using functional elements such as software keys accessible via the touch screen using a finger, stylus, etc. Alternatively, proximity sensors may be employed in connection with a screen such that an actual touch need not be registered in order to perform a corresponding task. Speech input could also or alternatively be utilized in connection with the user interface 76. As another alternative, the user interface 76 may include a simple key interface including a limited number of function keys, each of which may have no predefined association with any particular text characters. As such, the user interface 76 may be as simple as a display and one or more keys for selecting a highlighted option on the display for use in conjunction with a mechanism for highlighting various menu options on the display prior to selection thereof with the one or more keys. User instructions for the performance of a function may be received via the user interface 76 and/or an output such as by visualization, display or rendering of data may be provided via the user interface 76. In some embodiments, particularly where the system is embodied on a server, the user interface 76 may be omitted. However, in some embodiments, the user interface 76 may be utilized to provide an instruction from a user associated with the mobile terminal 10. In this regard, the instruction may define conditions under which particular data (e.g. an implicit recommendation) is to be gathered and/or communicated to a network entity such as a server or other network device.

The communication interface 82 may be embodied as any device or means embodied in either hardware, software, or a combination of hardware and software that is configured to receive and/or transmit data from/to a network and/or any other device or module in communication with an apparatus that is employing the communication interface 82 within the system. In this regard, the communication interface 82 may include, for example, an antenna and supporting hardware and/or software for enabling communications via a wireless communication network. Additionally or alternatively, the communication interface 82 may be a mechanism by which sensor data may be communicated to the processing element 74 and/or the sensor data processor 70.

The sensor data processor 70 may be embodied as any device or means embodied in either hardware, software, or a combination of hardware and software that is configured to perform the corresponding functions of the sensor data processor 70 as described below. In an exemplary embodiment, the sensor data processor 70 may be configured to receive an input of sensor data 84, for example, either by direct communication with a sensor (e.g., the local sensor 35 and/or the remote sensor 39) or via the communication interface 82 and convert the sensor data 84 into a format (e.g., digital data) for use by either or both of the context determiner 78, the implicit recommendation determiner 80. As indicated above, the sensor data 84 may include, for example, data related to an individual that is indicative of temperature, conductivity (e.g., of the skin), lighting conditions, time, motion, acceleration, location, voice stress, pressure detection, blood pressure, heart rate, etc., which may be received from sensors including, for example, a barometer, an accelerometer, a GPS device, a light or sound sensor, a thermometer, or numerous other sensors.

The context determiner 78 may be embodied as any device or means embodied in either hardware, software, or a combination of hardware and software that is configured to receive an input in the form of, for example, the sensor data 84 and/or other information and determine context information based at least in part on the input. In this regard, context information may be defined to include the circumstances and conditions associated with a particular content item, location or event. Thus, for example, if a photo is taken while on vacation, the context of the photo may include the location at which the photo was created, the individual taking the photo, individuals in the photo, the event (e.g., vacation) associated with the photo, time and date of the photo, etc. According to embodiments of the present invention, the context determiner 78 may be configured to utilize information from various sources, including the sensor data 84, to determine context information 86 which, along with the sensor data 84 may be communicated to the implicit recommendation determiner 80 for making determinations with respect to implicit recommendations associated with a particular event, content item or location.

In an exemplary embodiment, in addition to sensor data, information from other applications may be used for context determinations made by the context determiner 78. In this regard, for example, schedule information such as calendar, class schedule and/or personal planner information may be used to define or assist in the definition of an event or location as context information with which corresponding sensor data may be associated. As another alternative, if a particular content item is being displayed or otherwise rendered at the mobile terminal 10, sensor data gathered during the display or rendering of the particular content item may be used, potentially in addition to a context associated with the content item itself, to determine context information related to the viewing of the content item. The determined context information may then be communicated to the implicit recommendation determiner 80 along with the corresponding sensor data.

The implicit recommendation determiner 80 may be embodied as any device or means embodied in either hardware, software, or a combination of hardware and software that is configured to determine an implicit recommendation associated with a location, event or content item based on the sensor data 84 and the corresponding context information 86. In this regard, according to one embodiment, a series of rule based determinations may be performed by the implicit recommendation determiner 80 in order to generate an implicit recommendation. In an exemplary embodiment, the implicit recommendation determiner 80 may engage in an intermediate operation of determining an affective state of an individual and basing a determination with respect to the implicit recommendation on the affective state or based on the affective state and the context information. For example, as described above, statistical analysis of what sensor data may be expected to correlate with a given affective state of a user in a given context may be used to assign, based on a statistical likelihood, an affective state to be associated with given sensor data and context combinations. Thus, the implicit recommendation determiner 80 may include a rule list or look-up table for determining the affective state based on sensor data and context. The affective state (or the sensor data) could also or alternatively be included in a rule list or look-up table with the associated context for determination of a corresponding implicit recommendation.

The affective state could be any of a number of emotional states such as happy, sad, interested, bored, excited, angry, tense, or a host of other emotions or affective states. The affective state may then be used with or without context for determining an implicit recommendation. In this regard, different sensor data, and even different affective states, could be associated with different implicit recommendations. For example, exemplary sensor data corresponding to high skin conductivity coupled with motion may be indicative of different affective states in different contexts. In a class room context, the exemplary sensor data may indicate an embarrassed and fidgety student that was just asked a tough question. Meanwhile, in a night club context, the exemplary sensor data may indicate that an individual is enjoying and dancing to the current music. Additionally, an exemplary affective state may be indicative of different implicit recommendations in different contexts. In this regard, while an affective state of happiness may be assumed to provide an implicit recommendation of enjoyment in nearly all contexts, other affective states may have varying associated implicit recommendations dependent upon the corresponding context. For example, sadness may normally be considered to be a negative implicit recommendation with regard to a location, content, or an event. However, if an individual is watching an emotional movie, sadness may be indicative of the success of the movie maker and/or of enjoyment of the movie by the user.

As another example, a location of the mobile terminal 10 may be tracked or otherwise reported at a given time and sensor data gathered while at the location may be communicated to the implicit recommendation determiner 80 along with the location to attempt to determine an affective state of the individual in possession of the mobile terminal 10. The location may be used as either or both of sensor data and context information. The same may be said of numerous other types of sensor data.

In an exemplary embodiment, the implicit recommendation determiner 80 may be configured to determine an implicit recommendation, for example, continuously, at regular intervals, at predetermined times, in response to predetermined events, when content is rendered at the mobile terminal 10, or only when permitted or directed by the user. Thus, for example, when a new location, content item or event is recognized, a corresponding implicit recommendation may be determined. In some cases, a delay may be inserted prior to determining the implicit recommendation to attempt to ensure the affect of the new location, content item or event is fully realized. Alternatively, in response to encountering a new stimuli (e.g., the new location, content item or event) an initial, mid-term and final impression may be ascertained, for example, by determining the implicit recommendation at predetermined delayed intervals with respect to the new stimuli and/or upon an ending of the encounter.

For privacy concerns, the user may be enabled to provide an instruction related to when implicit recommendations may be determined and/or when information (e.g., sensor data, context information, affective state, and/or implicit recommendations) may be communicated, e.g., to a server. In this regard, the user may specify time periods, locations or other criteria to define when and/or how implicit recommendations may be determined (or may not be determined) for the user. Such limitations may not only address privacy concerns, but may also address battery consumption by enabling sensors and processing resources to be powered down during periods of non-use. As an alternative, since some information (e.g., user location) may be sensitive only when such information is current, despite an ability of the system to perform real-time calculations or determinations with respect to implicit recommendations, communication of recommendations or determination of recommendations may be performed on a delayed basis in order to ensure current location information for an individual is not disclosed.

In an exemplary embodiment, rather than having the timing and/or occurrence of implicit recommendation determinations being controlled by the user, it may be possible to enable content providers, or entities associated with particular events or locations to initiate or solicit implicit recommendations. In this regard, for example, a movie theater may include a server configured to communicate with mobile terminals belonging to corresponding movie watchers and, following or even during the movie, the server may request an implicit recommendation to be determined and/or communicated from a mobile terminal of a movie watcher. In one embodiment, the user may be prompted to release information to enable the server to determine the implicit recommendation or to release the implicit recommendation itself. However, in an alternative embodiment, the user may define particular entities as enabled or authorized to receive implicit recommendation related information, or the user may place the mobile terminal 10 in a permissive mode (e.g., enabling all inquiries with regard to implicit recommendations to be answered) or a non-permissive mode (e.g., denying all inquiries with regard to implicit recommendations). As such, the user may enable some or particular entities to receive implicit recommendation related information from the user's mobile terminal.

Once an implicit recommendation has been determined, the implicit recommendation may be communicated to another device for processing, or may be utilized, for example, by the processing element 74 for the performance of affective computing, which may be defined as computing or determinations that relate to, arise from, or deliberately influence emotions. Embodiments of the present invention may enable the unobtrusive inference of affect as it relates to an individual exposed to a location, event or content. The implicit recommendation may then be used, for example, by the processing element 74 in order to enable ranking and/or profiling of locations, events or content items. Polling, user satisfaction surveys, and other feedback may therefore be capable of collection without, or with relatively low user interaction. Ranking information may then be used, for example, to improve the results of a search engine by providing evidence regarding what individuals think and/or feel about a particular topic or item, which may influence how high the search engine ranks the particular topic or item. Alternatively or additionally, implicit recommendation information may be used to annotate a map display in association with particular events or locations such that particular events or locations (e.g., nightclubs, restaurants, museums, movies, plays, auto mechanics, etc.) may be found (or avoided) based on the implicit recommendations associated therewith.

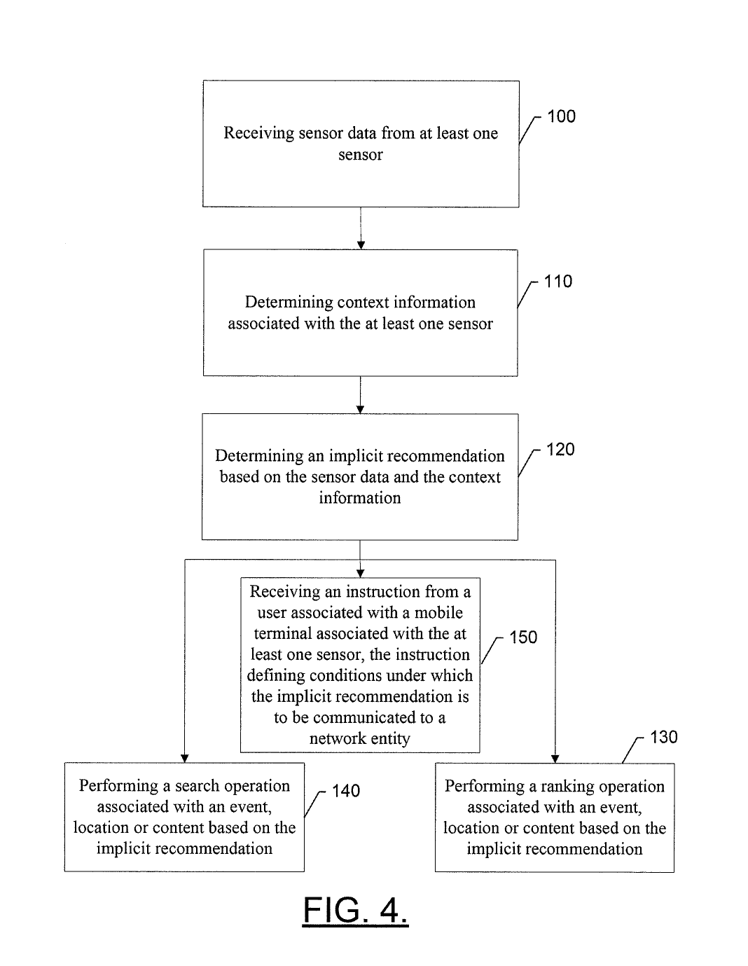

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal (or server) and executed by a built-in processor in the mobile terminal (or server). As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing a determination of implicit recommendations as illustrated, for example, in FIG. 4 may include receiving sensor data from at least one sensor at operation 100. At operation 110, context information associated with the at least one sensor may be determined. An implicit recommendation may then be determined based on the sensor data and the context information at operation 120. In an exemplary embodiment, the method may include a further optional operation 130 of performing a ranking operation associated with an event, location or content based on the implicit recommendation. Additionally or alternatively, the method may include an optional operation 140 of performing a search operation associated with an event, location or content based on the implicit recommendation. In this regard, performing the search operation may further include altering an ordering of presented links returned responsive to the search operation based on the implicit recommendation. As yet another alternative, an optional operation 150 of receiving an instruction from a user associated with a mobile terminal associated with the at least one sensor, in which the instruction defines conditions under which the implicit recommendation is to be communicated to a network entity.

In an exemplary embodiment, operation 100 may include receiving sensor data associated with a user of a mobile terminal from a sensor disposed at the mobile terminal or receiving sensor data associated with a user of a mobile terminal from a sensor disposed remotely with respect to the mobile terminal, but in wireless communication with the mobile terminal. Operation 110 may include determining context based at least in part on the sensor data or utilizing schedule and/or location information associated with a user associated with a mobile terminal associated with the at least one sensor in order to determine the context information. Operation 120 may include determining an affective state of a user of a mobile terminal based on the sensor data and the context information. In this regard, determining the affective state of the user may include determining information associated with an emotional state of the user based on rules defining a corresponding emotional state for given sensor data and context combinations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving sensor data from at least one sensor;
determining context information associated with the at least one sensor; and
determining an implicit recommendation based on the sensor data and the context information.

2. A method according to claim 1, wherein receiving sensor data comprises receiving sensor data associated with a user of a mobile terminal from a sensor disposed at the mobile terminal.

3. A method according to claim 1, wherein receiving sensor data comprises receiving sensor data associated with a user of a mobile terminal from a sensor disposed remotely with respect to the mobile terminal, but in communication with the mobile terminal.

4. A method according to claim 1, wherein determining the context information comprises determining context based at least in part on the sensor data.

5. A method according to claim 1, wherein determining the implicit recommendation comprises determining an affective state of a user of a mobile terminal based on the sensor data and the context information.

6. A method according to claim 5, wherein determining the affective state of the user comprises determining information associated with an emotional state of the user based on rules defining a corresponding emotional state for given sensor data and context combinations.

7. A method according to claim 1, further comprising performing a ranking operation associated with an event, location or content based on the implicit recommendation.

8. A method according to claim 1, further comprising performing a search operation associated with an event, location or content based on the implicit recommendation.

9. A method according to claim 8, wherein performing the search operation further comprises ordering a plurality of links returned responsive to the search operation based on the implicit recommendation.

10. A method according to claim 1, further comprising receiving an instruction from a user associated with a mobile terminal associated with the at least one sensor, the instruction defining conditions under which the implicit recommendation is to be communicated to a network entity.

11. A method according to claim 1, wherein determining the context information comprises utilizing schedule and location information associated with a user associated with a mobile terminal associated with the at least one sensor in order to determine the context information.

12. A computer program product comprising at least one computer-readable storage medium having computer-readable program code portions stored therein, the computer-readable program code portions comprising:
a first executable portion for receiving sensor data from at least one sensor;
a second executable portion for determining context information associated with the at least one sensor; and
a third executable portion for determining an implicit recommendation based on the sensor data and the context information.

13. A computer program product according to claim 12, wherein the first executable portion includes instructions for receiving sensor data associated with a user of a mobile terminal from a sensor disposed at the mobile terminal.

14. A computer program product according to claim 12, wherein the first executable portion includes instructions for receiving sensor data associated with a user of a mobile terminal from a sensor disposed remotely with respect to the mobile terminal, but in communication with the mobile terminal.

15. A computer program product according to claim 12, wherein the third executable portion includes instructions for determining an affective state of a user of a mobile terminal based on the sensor data and the context information.

16. A computer program product according to claim 12, further comprising a fourth executable portion for receiving an instruction from a user associated with a mobile terminal associated with the at least one sensor, the instruction defining conditions under which the implicit recommendation is to be communicated to a network entity.

17. An apparatus comprising a processing element configured to:
receive sensor data from at least one sensor;
determine context information associated with the at least one sensor; and
determine an implicit recommendation based on the sensor data and the context information.

18. An apparatus according to claim 17, wherein the processing element is further configured to receive sensor data associated with a user of a mobile terminal from a sensor disposed at the mobile terminal.

19. An apparatus according to claim 17, wherein the processing element is further configured to receive sensor data associated with a user of a mobile terminal from a sensor disposed remotely with respect to the mobile terminal, but in communication with the mobile terminal.

20. An apparatus according to claim 17, wherein the processing element is further configured to determine an affective state of a user of a mobile terminal based on the sensor data and the context information.

21. An apparatus according to claim 17, f wherein the processing element is further configured to receive an instruction from a user associated with a mobile terminal associated with the at least one sensor, the instruction defining conditions under which the implicit recommendation is to be communicated to a network entity.

22. An apparatus comprising:
means for receiving sensor data from at least one sensor;
means for determining context information associated with the at least one sensor; and
means for determining an implicit recommendation based on the sensor data and the context information.

23. An apparatus according to claim 22, wherein means for determining the implicit recommendation comprises means for determining an affective state of a user of a mobile terminal based on the sensor data and the context information.

24. An apparatus comprising a processing element configured to:
receive an implicit recommendation, the implicit recommendation being determined based on sensor data and associated context information;
receive a search query related to an event, location or content; and
provide search results based at least in part on the implicit recommendation.

25. An apparatus according to claim 24, wherein the processing element is further configured to order a plurality of links of the search results based on the implicit recommendation.
